(19) United States
(12) Patent Application Publication
(10) Pub. No.: US 2026/0217599 A1
(43) Pub. Date: Jul. 30, 2026

(54) METHOD FOR COATING AN OPTICALLY REFLECTIVE LAYER ON A WAVEGUIDE AND SCREEN PRINTING DEVICE

(71) Applicant: Applied Materials, Inc., Santa Clara, CA (US)

(72) Inventors: Marco GALIAZZO, Quinto di Treviso (IT); Ludovic GODET, Menlo Park, CA (US); Gaia FRANDOLI, Ponte di Piave (IT)

(21) Appl. No.: 19/146,739

(22) PCT Filed: Feb. 10, 2023
(86) PCT No.: PCT/EP2023/053363

§ 371 Date: Jul. 9, 2025

(51) Int. Cl. C03C 17/10; G02B 6/34

(52) U.S. Cl. CPC C03C 17/10; G02B 6/34; C03C 2217/256; C03C 2218/119

(57) ABSTRACT

A method for coating an optically reflective layer on a waveguide having an in-coupler grating, the method comprising:
depositing an ink by screen printing on the in-coupler grating of the waveguide.

### FIELD

Embodiments described herein relate to methods for coating an optically reflective layer on a waveguide having an in-coupler grating and for screen printing devices. Embodiments described herein further relate to waveguides with an in-coupler grating and to lenses including an optical waveguide.

### BACKGROUND

Virtual reality is generally considered to be a computer-generated simulated environment of which a user has perception/experience. A virtual reality experience can be generated in 3D and viewed with a head-mounted display (HMD), such as glasses or other wearable display devices that have near-eye display panels as lenses to display a virtual reality environment that is experienced instead of an actual environment.

Augmented reality enables an experience in which a user can still see through the display lenses of the glasses or other HMD device to view the surrounding environment, yet also sees images of virtual objects that are generated for display and appear as superimposed to the environment. Augmented reality can include any type of input, such as audio and haptic inputs, as well as virtual images, graphics, and video that enhance or augment the environment that the user experiences. As an emerging technology, there are many challenges and design constraints with augmented reality.

In order to allow for a computer-generated virtual image to be combined with a real-world image of the environment so as to provide an augmented reality experience, optical combiners may be used. Such optical combiners may involve waveguides that include a substrate having a plurality of optical structures formed thereon.

An optical combiner may involve the use of a lens with a waveguide, in particular with a waveguide having input and/or output couplers and configured for example such that light rays of a computer-generated image incident on the input coupler are transmitted through the waveguide reaching e.g. the output coupler where the light is then finally directed towards the eye(s) of a human user in superposition with light from the physical world passing through the lens.

The efficiency of the input coupler is relevant for the efficiency of the optical combiner and/or for the quality of the superimposed image. There is therefore a need to improve an input coupler and/or a waveguide and a lens for augmented reality of virtual reality applications.

### SUMMARY

The invention is defined by the independent claims. The dependent claims define further embodiments of the invention.

According to an aspect, the present disclosure discloses a method for coating an optically reflective layer on a waveguide having an in-coupler grating, the method comprising:
depositing an ink by screen printing on the in-coupler grating of the waveguide.

The present disclosure further discloses a waveguide with an in-coupler grating having a particle-free optically reflective layer generated by the deposition and sintering of a particle free-ink adhering to the in-coupler grating, wherein the optically reflective layer adhering to the in-coupler grating of the waveguide is obtained with the methods of the present disclosure.

The present disclosure further discloses a lens including the optical waveguide of the present disclosure having a length from 40 mm to 80 mm and a width from 20 mm to 60 mm.

According to a further aspect, the present disclosure discloses a screen printing device comprising:
a loading and unloading system for waveguides;
a handling system configured to handle waveguides loaded by the loading and unloading system;
one or more alignment systems and one or more actuators configured to align and move waveguides handled by the handling system; and
one or more screen printing heads each comprising a screen, one or more squeegees and one or more floodbars configured to apply an ink on waveguides aligned and moved by the one or more alignment systems.

### BRIEF DESCRIPTION OF THE DRAWINGS

FIG. 1A shows details of a top view of a lens including a waveguide according to embodiments of the present disclosure.

FIG. 1B shows details of a side view of a waveguide according to embodiments of the present disclosure.

FIG. 1C shows the propagation of light within and/or through a waveguide according to embodiments of the present disclosure.

FIG. 2A shows a side view of a waveguide having an in-coupler grating with an optically reflective layer according to embodiments of the present disclosure.

FIG. 2B shows a side view of a waveguide having an in-coupler grating with an optically reflective layer according to embodiments of the present disclosure and further illustrates the presence of a protective coating according to embodiments of the present disclosure.

FIG. 2C shows details of an in-coupler grating of a waveguide according to embodiments of the present disclosure.

FIG. 2D shows details of a reflective layer on an in-coupler grating of a waveguide according to embodiments of the present disclosure.

FIG. 3A shows a screen-printed protective mask having a negative pattern of an in-coupler grating according to embodiments of the present disclosure.

FIG. 3B shows a screen-printed protective mask having a negative pattern of an in-coupler grating according to embodiments of the present disclosure and further shows an optically reflective layer on a waveguide having an in-coupler grating according to embodiments of the present disclosure.

FIGS. 3C and 3D show an optically reflective layer on a waveguide having an in-coupler grating according to embodiments of the present disclosure.

FIGS. 4A and 4B show a screen-printing device according to embodiments of the present disclosure.

FIG. 5 illustrates a method for coating an optically reflective layer on a waveguide having an in-coupler grating according to the present disclosure.

FIG. 6 shows a waveguide stack including several waveguides according to the present disclosure.

### DETAILED DESCRIPTION

In the following description the connective “or” has not to be intended as exclusive or (xor), unless otherwise stated. Therefor the text “or” and the text “and/or” are intended to define the same connective that in particular evaluates to true in the case that both operands are true.

Embodiments described herein involve optical devices. A device may be considered an optical device if the optical properties of the device are relevant for the method or apparatus in which the device is used. At least a portion of an optical device can be made of a transparent material, such as glass or plastic. Some optical devices may be configured to change the properties, e.g. the propagation direction, of light. For example, an optical device may include optical structures for changing the propagation direction of light. Other optical devices may be unstructured and allow light to pass therethrough substantially unaltered. An optical device as described herein may be an optical device for use in augmented reality applications. An optical device can also be called an optical element. Examples of optical devices include waveguides and transparent cover elements, such as cover glasses, as described herein.

An optical device as described herein, such as a waveguide or a transparent cover element, can be a thin piece of material. An optical device can be a plate element, including a plate element having a flat surface or a plate element having a curved surface. An optical device can have a first major surface and a second major surface opposite the first major surface. An optical device may be a substantially two-dimensional device, wherein a thickness of the optical device between the first major surface and the second major surface can be much smaller (e.g. 1% or less) than a dimension, such as a length or width, of the first or second major surface.

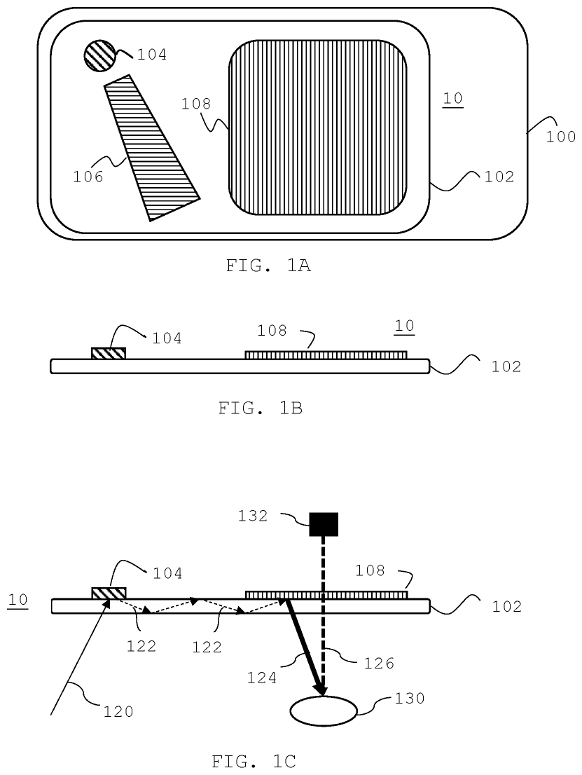

FIG. 1A shows details of a top view of a lens 100 including a waveguide 10 according to embodiments of the present disclosure.

The waveguide 10 may include and/or be formed by a substrate 102, which may be a thin piece of transparent material, such as glass or plastic. The waveguide 10 may include an input coupler grating 104 defined by a grating structure that may be disposed on the substrate 102. The waveguide 10 may include an output coupling region defined by an out-coupler grating 108 that may be disposed on the substrate 102. Light, in particular light corresponding to a virtual, computer-generated image, may be coupled into the waveguide 10 at the input coupling region formed by the in-coupler grating 104. The light may propagate through the waveguide 10 until the light reaches the out-coupler grating 108.

At the out-coupler grating 108, the light may exit the waveguide 10. Further, also at the output coupling region formed by the out-coupler grating 108, light from the external, real-world surroundings may be transmitted through the waveguide 10, allowing the user to see a combination of a virtual image and a real-world image. The waveguide 10 may be a waveguide combiner for providing an augmented reality experience to a user.

In augmented reality and/or virtual reality devices, an image that is typically computer generated is transferred to the eye of a human user that perceives said image as superimposed onto the physical environment and/or in place of the physical environment surrounding the user.

For example, a lens including a waveguide may be used to combine a computer-generated image with the light of the physical environment such that the user effectively sees a superposition of the physical environment with the computer-generated image.

The computer-generated image may include any type of data. For example, the computer-generated image may include images recorded in a different location and/or time instant. For example, the computer-generated image may display data processed by a computer and/or transmitted via a communication network and/or by a cloud computing system and/or via a network and/or the Internet.

The computer-generated image may include the transmission of any type of data/information that a human eye can receive, including data encoded/presented as text and/or numbers.

The computer-generated image may be updated in real time such that the user may experience a sequence of computer-generated images. Said sequence may be part of a video that the user may experience as included in the virtual reality or as being in superposition to the perception of the surrounding reality.

The computer-generated image, as a static image or as included in a video, may be generated through any suitable projector system or light emitting system configured to display images and/or videos.

The image is then combined/superimposed with light from the physical environment or replaces the light of the physical environment when entering the eye of a human user located in the physical environment that then experiences the generated augmented reality or the virtual reality, respectively.

The combination may be carried out using a lens with a waveguide.

The lens 100 may include further waveguides, in particular further waveguides for different wavelengths or ranges of wavelengths. For example, a lens 100 may include three waveguides for each color range of an additive color model, like for example a RGB color (red green blue color model).

The waveguide 10 has an in-coupler grating 104.

An exit pupil expander 106 may be optionally included in the waveguide 10.

The in-coupler grating 104 receives a light beam, for example a light beam emitted by a projector or any light emitting device projecting a computer-generated image, for example a light beam of a color channel like e.g. a RGB color channel.

The light beam received by the in-coupler grating 104 is then transferred within the waveguide 10 towards an out-coupler grating 108. The light beam travels as light within the waveguide 10 reaching the out-coupler grating 108 from the in-coupler grating 104. The waveguide 10 may use an exit pupil expander 106 configuration in order to produce a proper eye box region such that the out-coupler grating 108 provides an output beam that is perceived as focused and sharp by the human user. The function of the eye pupil expander is to propagate and extend the size of the light beam to match the output coupler.

FIG. 1B shows details of a side view of a waveguide according to embodiments of the present disclosure. FIG. 1B shows in particular the in-coupler grating 104 and the out-coupler grating 108 disposed on the substrate 102 of the waveguide 10.

FIG. 1C shows the propagation of light within and/or through a waveguide 10 according to embodiments of the present disclosure.

Incident light 120, typically from a projector or light emitting device (not shown in the picture), reaches the in-coupler grating 104 of the waveguide 10 of the lens 100.

The incident light 120 is then at least in part reflected by the in-coupler grating 104 of the waveguide 10 and propagates within the waveguide 10 and/or within the exit pupil expander 106 and/or the substrate 102 as propagating light 122. The propagating light 122 then reaches the out-coupler grating 108 that produces an output light beam 124 typically reaching the human eye(s) 130 of a human user. Alternatively, an animal eye or a video camera may replace the human eye 130.

In the case of an augmented reality application, a further external light beam 126 originating from the external physical environment 132 may also pass through the waveguide 10 in the lens 100 such that a proper combination/superposition of the output light beam 124 and the external light beam 126 is implemented. In this way the computer-generated image projected as incident light 120 is combined together with the perception of the physical environment 132, and the human eye 130 of the user experiences a superposition of the vision of the physical environment 132 and the computer-generated image.

To obtain a virtual reality application, the external light beam 126 originating from the physical environment 132 may be blocked such that the user experiences only the computer-generated image transmitted by the incident light 120.

A proper arrangement of the lens 100 including one or more waveguides 10 may produce a smooth color and/or 3D vision for an augmented reality and/or virtual reality application.

To improve the vision experienced by the human eye 130 of the user, it is beneficial to maximize the reflection of the incident light 120 at the in-coupler grating 104 to maximize the propagating light 122.

The present disclosure provides an improved in-coupling of the incident light 120 into the waveguide 10.

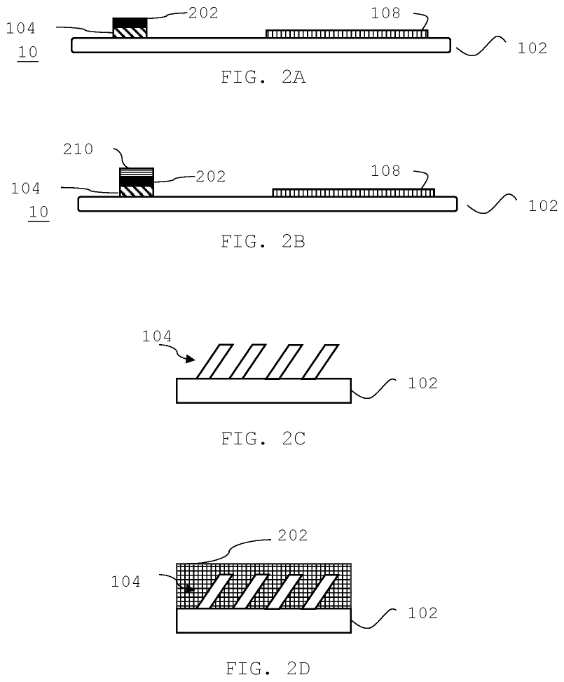

FIG. 2A shows a side view of a waveguide 10 having an in-coupler grating 104 with an optically reflective layer 202 according to embodiments of the present disclosure.

In the present disclosure, an optically reflective layer 202 is coated on a waveguide 10 having an in-coupler grating 104. According to methods of the present disclosure, an ink is deposited by screen printing on the in-coupler grating 104 of the waveguide 10. The ink may be a particle-free ink. The ink may be a silver ink. A treatment, like for example thermal treatment or a sintering process or UV curing may then be applied to the ink to obtain the optically reflective layer 202. The optically reflective layer 202 may be obtained specifically on the in-coupler grating 104 to improve a reflection of the incident light 120 into the waveguide 10, improving or maximizing the propagating light 122 within the waveguide 10.

The present disclosure solves the problem of coating an optically reflective layer on the nanostructure formed by the in-coupler grating in atmosphere.

The optically reflective layer 202 improves the in-coupling of the incident light 120 into the waveguide 10, thereby improving the propagating light 122 to obtain an improved image presented to the human eye 130.

Without the optically reflective layer 202, the first order diffraction percentage, i.e. the light that is collected in the waveguide for total internal reflection, is for example around 10% at the in-coupler and similarly the light collected from the waveguide is for example around 10% at the out-coupler, with an overall efficiency (input to output) of 1%. Adding the reflective layer 202 at the in-coupler it is possible to have for example an increase to 50%, with coupling overall efficiency of 5%.

The present disclosure relates for example to methods of coating on nanostructures, for example on the in-coupler grating of the waveguide, that are formed by glass, high refractive index surfaces or a combination of the two, for example by a glass or SiC substrate that is coated with metal oxides that are nanostructured. In some embodiments, the waveguide 10 consists of or includes a glass substrate or a substrate with a refractive index greater than 1.8.

Embodiments of the present disclosure relate to a specialty material that is adhered to the nanostructures of the substrate and is optically reflective.

FIG. 2B shows a side view of a waveguide 10 having an in-coupler grating 104 with an optically reflective layer 202 according to embodiments of the present disclosure and further illustrates the presence of a protective coating layer 210 according to embodiments of the present disclosure.

In some embodiments, the material forming the optically reflective layer 202 is obtained by an ink, in particular a particle free ink and is deposited by screen printing on top of the in-coupler grating 104 structures of a lens/waveguide. The optically reflective layer may then be protected by a resist which prevents oxidation and tarnishing effects.

The deposition of the ink to obtain the optically reflective layer 202 may be carried out by an additive process based on silk-screen printing.

In some embodiments, a protective coating 210 is applied on the optically reflective layer 202, for example on the ink after the ink is treated with for example a thermal treatment or a sintering process or a UV curing.

The problem solved by the present disclosure is to deposit a material that works as an optical mirror in the visible wavelength range upon treatment, the material forming the optically reflective layer 202. A processing of a substrate is carried out to obtain the optically reflective layer 202. The substrate may consist of the waveguide 10 having in-coupler grating 104.

The present disclosure solves the problem of coating on nanostructures on substrates in atmosphere with an additive or subtractive deposition method. A pattern is deposited on top of the in-coupler grating. The pattern may involve the use of particle free inks, in particular particle free Ag-inks (silver inks). The pattern forms the optically reflective layer 202. The pattern/optically reflective layer 202 is deposited on top of the in-coupler grating 104 to increase the coupling efficiency due to high optical reflectivity of the treated material.

Particle free silver inks could achieve a higher reflectivity than deposited aluminum, thereby providing an improved optically reflective layer 202 on the in-coupler grating 104 of the waveguide that improves the reflection of the incident light 120, providing a better in-coupling into the waveguide 10.

The present disclosure furthermore overcomes the limitation of deposited aluminum, in particular the limitations related to masking and sputtering or physical vapor deposition of aluminum which are expensive and slow.

The subject-matter of the present disclosure can be combined with other processes for example to define electrical circuits.

The optically reflective layer 202 provides for example an optical mirror obtained with a particle-free ink using screen printing.

The substrate to be processed, e.g. the waveguide 10 with in-coupler grating 104, could be for example:
a glass substrate with a refractive index (RI) greater than 1.45 (RI>1.45) with planar or nano-structured coatings forming for example the substrate 102 and/or the in-coupler grating 104,
a high refractive index substrate (RI>1.8) with planar or nano-structured coatings forming for example the substrate 102 and/or the in-coupler grating 104, or
a plastic substrate with planar or nano-structured coatings forming for example the substrate 102 and/or the in-coupler grating 104.

The screen printing may be carried out on:
a round wafer of 150 mm to 300 mm, 0.3 mm to 0.8 mm thickness that includes a plurality of waveguides 10, or
a single waveguide/lens (after the wafer has been diced) with typical dimensions of 40-80 mm in length by 20-60 mm in width.

The deposited material to form the optically reflective layer 202 could be:
a particle-free ink, or
a metal particle ink.

A wafer may be a glass substrate where one or more waveguides are present, for example a plurality of waveguides that are not yet diced/singulated.

FIG. 2C shows details of an in-coupler grating 104 of a waveguide 10 according to embodiments of the present disclosure.

For example, the in-coupler grating 104 may be formed by a set of gratings having the shape of slanted fins disposed on the substrate 102, as exemplarily shown in FIG. 2C, and/or any other suitable shape to implement an in-coupling function into the substrate 102 of the waveguide.

A grating as shown in FIG. 2C may be the grating structure of the in-coupler grating 104 or the grating structure of the out-coupler grating 108, and may accordingly serve to provide an input coupling region or an output coupling region of the waveguide 10. The grating structure may be formed on a major surface of the substrate 102. The grating structure may include a plurality of optical structures. The optical structures may be configured to change a propagation direction of light incident on the grating structure. The optical structures may have dimensions, e.g. width and/or height, that lie in the sub-micron and even nanometer range. The optical structures may be arranged adjacent to each other with a gap in between. The optical structures may be shaped, for example, as slanted fins.

The disclosure is not limited to the exemplary waveguide in FIGS. 1A-2D and applies likewise to other waveguides. For example, a waveguide may have more than two grating structures (e.g. the waveguide may have one or more intermediate regions defined by further grating structures), the arrangement and shape of the optical structures may be different from the example shown in FIG. 2C, the waveguide may have grating structures disposed on both sides of the waveguide, and so on.

A waveguide 10 as described herein may include a substrate 102. A waveguide may include a plurality of optical structures formed on the substrate. The optical structures may have sub-micro-dimensions, e.g. nano-sized dimensions. The plurality of optical structures may form one or more grating structures on the substrate. A waveguide can be a waveguide combiner. A waveguide combiner may be configured for combining a virtual computer-generated image with a real-world image of a surrounding environment. A waveguide may be an augmented reality waveguide combiner.

In an optical system, such as an augmented reality device, several waveguides may be stacked on top of each other to form a waveguide stack. For example, each waveguide in the waveguide stack may be configured for manipulating light at a respective wavelength range, which is beneficial for providing color images.

FIG. 2D shows details of an optically reflective layer 202 on an in-coupler grating 104 of a waveguide 10 according to embodiments of the present disclosure.

The optically reflective layer 202 is formed above and/or between the slanted fins disposed on the substrate 102 of the waveguide 10, thereby improving a reflection of the incident light 120.

The deposition method could be any of the following processes or any combination thereof:
an additive process based on silk-screen printing, ink jetting, dispensing, aerosol using a positive pattern to obtain the optically reflective layer 202 by screen printing,
a subtractive process based on a protective mask that has the negative pattern of the mirror/in-coupler grating, combined with silk-screen printing, ink jetting, dispensing, aerosol or spin coating,
the protective mask may be a screen printed protective mask and/or may be a water-soluble polymeric material deposited by ink jetting with 2-5 um thickness and 10-20 um resolution, or
a combination of the previous methods.

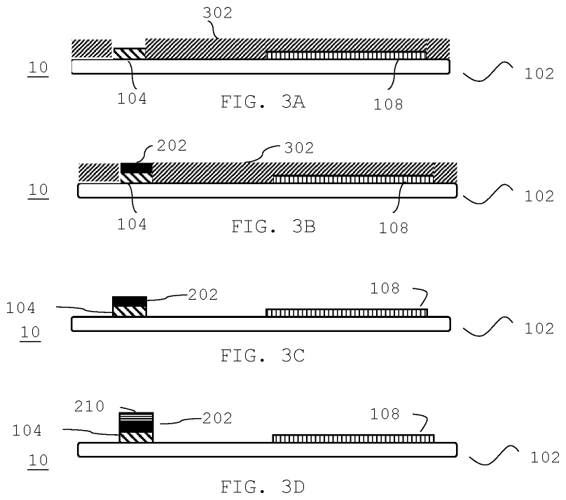

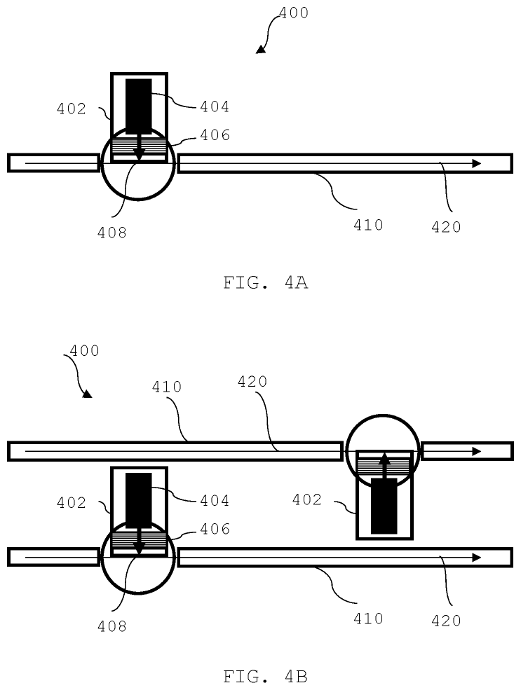

FIG. 3A shows a screen-printed protective mask 302 having a negative pattern of an in-coupler grating 104 according to embodiments of the present disclosure.

FIG. 3B shows a screen-printed protective mask 302 having a negative pattern of an in-coupler grating 104 according to embodiments of the present disclosure and further shows an optically reflective layer 202 on a waveguide 10 having an in-coupler grating 104 according to embodiments of the present disclosure.

The reflective layer 202 may be obtained by silk-screen printing.

FIGS. 3C and 3D show an optically reflective layer 202 on a waveguide having an in-coupler grating according to embodiments of the present disclosure. The optically reflective layer 202 may be obtained after removing the screen printed protective mask 302 or, alternatively, after removing the water-soluble polymeric material deposited by ink jetting to form an alternative protective mask.

An alignment method of the screen could be for example based on:
fiducial marks on the wafer or single waveguide,
edge of the wafer (notch) or single waveguide,
patterned nanostructures on the wafer or single waveguide, or
a combination of the methods above.

The treatment applied to the deposited material could be:
thermal, applying conductive, convective, irradiation (photonic, laser) heating or a combination thereof,
UV curing,
a two-step process including one step to evaporate solvents present in the deposited material and one step to achieve optical properties by for example sintering or curing, or
a combination of the methods above.

A protective coating layer 210 applied to the material as encapsulant may be deposited with one of the following methods:
the deposition method of the protective coating could be the same as the optical material or different (for example silk-screen printing, ink jetting, aerosol, spin-coating),
the curing method could be the same as the optical material or different (thermal or UV),
the coating prevents oxidation and/or corrosion of the optical material, and/or
the coating improves the adhesion and durability of the optical material.

The printing may be screen printing, for example silk-screen printing.

In the case of silk-screen printing in any of the methods previously described, for example for coating an optically reflective layer on a waveguide having an in-coupler and/or for a protective coating, the screen could be:
a traditional screen with wire mesh and planar emulsion,
a stepped screen with wire mesh and two-levels of emulsion, where the lower thickness of emulsion is useful to reduce the effective force acting on the substrate during the printing process, or
a metal stencil with stepped thickness, where the metal thickness of emulsion is useful to reduce the effective force acting on the substrate during the printing process.

If the deposited material is electrically conductive upon treatment, it could be used to create electrical circuits along the profile of each lens.

The deposited material could be deposited and treated simultaneously in the mirror area, e.g. the lens in-coupler, and in other areas of the lens.

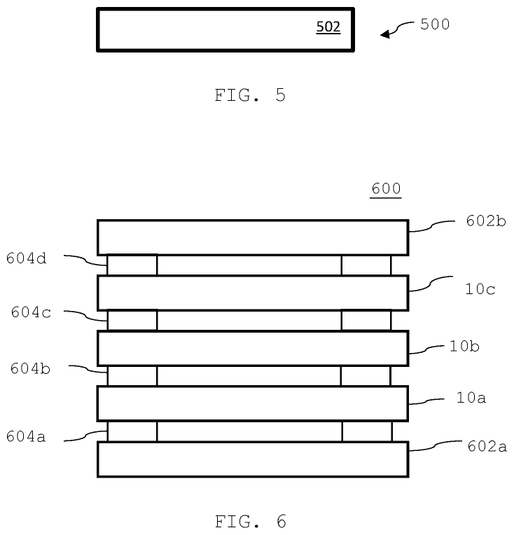

FIGS. 4A and 4B show a screen-printing device 400 according to embodiments of the present disclosure.

The screen printing device 400 includes:
a loading and unloading system for waveguides,
a handling system configured to handle waveguides loaded by the loading and unloading system,
one or more alignment systems 408 and one or more actuators configured to align and move waveguides handled by the handling system, and
one or more screen printing heads 402 each comprising a screen 406, one or more squeegees 404 and/or one or more floodbars configured to apply an ink on waveguides aligned and moved by the one or more alignment systems.

The screen printing device and in particular the loading and unloading system of the screen printing device may handle waveguides in a glass wafer, for example around 20 waveguides in a 300 mm wafer, or separated and already cut waveguides that may be arranged in a specific printing chuck with a precise alignment and multiple printing processes, or that may alternatively be separated and printed one at a time.

In some embodiments, the waveguides are a plurality of waveguides in a glass wafer, or a plurality of separated and already cut waveguides arranged in a printing chuck, or a single waveguide.

A single screen may be used to screen print on a plurality of waveguides, either in a glass wafer, or separated and arranged in a printing chuck. A conveyor system 410 may carry the wafer/lens/waveguides to and/or from the handling system for processing. The wafer/lens/waveguides forming the substrate to be processed may be moved in a moving direction 420 that may be substantially parallel to the screen 406.

More particularly, in the case of application by screen printing, the equipment may for example be composed of:
a manual or automatic loading and unloading system for: wafers, single waveguides/lenses or trays of waveguides/lenses,
one or more alignment systems 408 based on an optical camera, a dedicated illumination system and a group of actuators in X, Y and angular directions, wherein the alignment system is capable of detecting either a substrate edge, fiducials or patterned nanostructures and wherein actuators are either moving the substrate, the printing screen or both,
one or more screen printing heads 402 composed of a screen 406, one or more squeegees 404 and one or more floodbars,
an optional air filtering system (FFU) for cleanrooms graded 1,000 or higher,
an optional treatment station which could be embedded in the printing module (thermal or UV),
a handling system (i.e. rotary table, linear shuttles, . . . ) to carry the wafer/lens on the processing station and to hold the wafer/lens during the process (i.e. printing), and/or
a conveyor system 410 to carry the wafer/lens to and/or from the handling system for the processing.

The screen-printing device 400 may handle one or more waveguides in parallel. For example, FIG. 4A shows a screen-printing device 400 including one printing head 402, whereas the screen-printing system 400 as illustrated alternatively in FIG. 4B includes in particular two printing heads 402, thereby allowing a parallel printing on substrates.

Other embodiments may include one, two or more printing heads 402 and/or a varying number and arrangement of components in order to print in parallel on multiple substrates.

FIG. 5 illustrates a method 500 for coating an optically reflective layer 202 on a waveguide 10 having an in-coupler grating 104 according to the present disclosure.

The method 500 for coating an optically reflective layer 202 on a waveguide 10 having an in-coupler grating 104 includes:
depositing 502 an ink by screen printing on the in-coupler grating 104 of the waveguide 10.

FIG. 6 shows a waveguide stack 600 including several waveguides according to the present disclosure. The waveguide stack 600 may be included for example in a lens 100.

A waveguide stack 600 may include a cover glass 602a (e.g. a bottom cover glass), a waveguide 10a, a waveguide 10b, a waveguide 10c and a cover glass 602b (top cover glass) stacked in this order. An adhesive 604a may be disposed between the cover glass 602a and the waveguide 10a. Adhesives 604b, 604c and 604d may be disposed between waveguides 10a and 10b, between waveguides 10b and 10c, and between waveguide 10c and cover glass 602b, respectively. Each of the waveguides 10a-c may be a waveguide as described herein, such as a waveguide 10.

A cover glass, such as cover glasses, may be a protective glass. A cover glass may shield a surface of a waveguide adjacent to the cover glass, for example to prevent a grating formed on said surface from being contacted or contaminated. A cover glass itself may not have optical structures, such as a grating.

An adhesive, such as adhesives 604a-d, may be configured to attach adjacent optical devices of a waveguide stack to each other. For example, adhesive 604a may be configured to attach cover glass 602a to waveguide 10a. An adhesive may be a pressure sensitive adhesive (PSA). An adhesive may be a pre-formed adhesive, such as a pre-formed PSA. An adhesive may have an elongated shape. For example, an adhesive may be an adhesive tape. An adhesive may function as a spacer providing a gap, particularly an air gap, between adjacent optical devices of the waveguide stack. Due to the adhesive, said adjacent optical devices may not contact each other.

The waveguide stack 600 shown in FIG. 6 includes a total of three waveguides. The disclosure is not limited thereto. A waveguide stack may include 1 or more, 2 or more, or 3 or more waveguides. For example, a waveguide stack may include a total of 2 waveguides stacked between a cover glass 602a and a cover glass 602b.

Further, instead of cover glasses, transparent cover elements made of materials other than glass may be used in a waveguide stack. Throughout the present disclosure, a cover glass may be replaced by a transparent cover element.

In some embodiments of the method 500, the ink may be a particle-free ink. The ink and/or the ink after the application of a treatment to the ink forms the optically reflective layer 202.

In the following, relevant embodiments of the present disclosure are compactly summarized.

In some embodiments of the method 500, the ink is a particle-free ink. In some embodiments, the particle-free ink may be a silver ink.

In some embodiments, the waveguide 10 includes a glass substrate or a substrate with a refractive index greater than 1.8.

In some embodiments, the waveguide may be included in a lens having a length from 40 mm to 80 mm and a width from 20 mm to 60 mm. For example, the screen printing may be carried out on a single lens, on a plurality of single lenses or on a substrate where lenses are present but not singulated yet, using a single screen.

In some embodiments, the screen printing is carried out on a single waveguide, on a plurality of diced waveguides, or on a wafer/glass substrate where waveguides are present but not yet diced, using a single screen.

In some embodiments, the deposition of the ink is carried out by an additive process based on silk-screen printing.

The additive process produces the optically reflective layer 202 on the in-coupler grating 104 of the waveguide 10.

In some embodiments, the deposition of the ink is carried out by a subtractive process based on a screen printed protective mask 302 having a negative pattern of the in-coupler grating 104 combined with silk-screen printing.

In some embodiments, the method 500 further comprises applying a treatment to the ink, wherein the treatment is a thermal treatment or a sintering process or a UV curing; and applying a protective coating 210 on the treated ink.

The present disclosure further discloses a waveguide 10 with an in-coupler grating 104 having a particle-free optically reflective layer 202 generated by the deposition and sintering of a particle-free ink adhering to the in-coupler grating, wherein the optically reflective layer 202 adhering to the in-coupler grating of the waveguide is obtained with the methods of the present disclosure.

The particle-free ink is the particle-free ink that forms the optically reflective layer 202 according to the present disclosure.

The present disclosure further discloses a lens including the optical waveguide 10 according to the present disclosure and having a length from 40 mm to 80 mm and a width from 20 mm to 60 mm.

The present disclosure further discloses a screen printing device 400 comprising:
a loading and unloading system for waveguides;
a handling system configured to handle waveguides loaded by the loading and unloading system;
one or more alignment systems 408 and one or more actuators configured to align and move a waveguide handled by the handling system; and
one or more screen printing heads 402 each comprising a screen 406, one or more squeegees 404 and one or more floodbars configured to apply an ink on a substrate aligned and moved by the one or more alignment systems.

A conveyor system 410 may carry the wafer/lens/waveguides to and/or from the handling system for processing/printing.

In some embodiments, the ink is a particle free ink and a silver ink.

In some embodiments, the screen printing device further comprises an air filtering system for cleanrooms of class 1000 or higher.

Screen printing of particle-free inks according to the present disclosure deliver higher throughput and lower cost and provide an improved reflectivity and an improved in-coupler of a waveguide 10.

Methods of the present disclosure provide in particular an improved coating of an improved optically reflective layer 202 on a waveguide 10 having an in-coupler grating 104. The depositing by screen printing provides higher throughput and lower cost as compared to waveguides without such a coating, thereby improving the method for coating an optically reflective layer on a waveguide having an in-coupler grating.

For example, in a typical printing process and configuration, with screen printing and for example a print on print, for each print step a range of 2 to 5 seconds may for example be required. In comparison a typical ink-jetting head with one nozzle would require for example around 20-30 minutes to produce the same pattern. Even using a high number of nozzles in parallel, the time of screen printing would be at least comparable and/or still advantageous.

Due to the lower viscosity of the ink-jet inks that may be of orders of magnitude, there is a significant spreading over grating structures whereas thicker materials can provide a significantly improved pattern fidelity. The present application therefore typically provide a significantly improved pattern fidelity and/or improves the time required for producing the pattern.

The particle-free ink, in particular the silver ink, improves the optically reflective layer 202 on a waveguide 10 having an in-coupler grating 104, providing a better reflectivity that improves the light coupled into the waveguide 10 and/or the propagating light 122, thereby providing an improved in-coupler.

The depositing 502 of the ink by screen printing further provides an improved and more uniform optically reflective layer 202, thereby further contributing to the improvement of the reflectivity of the in-coupler and further improving the in-coupling of the incident light 120 into the waveguide 10 and/or into the substrate 102 of the waveguide 10.

Screen printing improves processing time. For example, if an ink-jet system produces a certain pattern in minutes, screen printing typically produces the same pattern in seconds.

The patterning capability of the screen printing and/or the quality of the obtained optically reflective layer are typically improved, because the paste/ink has a higher viscosity and it stays in place better than when using ink-jet methods. The pattern capability and/or the quality of the obtained reflective layer are evaluated for example considering placement precision and accuracy in reproducing the pattern/the optically reflective layer.

Moreover, the adhesion of the ink on the substrate and/or on the in-coupler grating is improved when using screen printing, as an effect of the application of a pressure during the paste/ink transfer during screen printing.

1. A method for coating an optically reflective layer on a waveguide having an in-coupler grating, the method comprising:
depositing an ink by screen printing on the in-coupler grating of the waveguide.

2. The method of claim 1, wherein the ink is a particle-free ink.

3. The method of claim 2, wherein the particle-free ink is a silver ink.

4. The method of claim 1, wherein the waveguide includes a glass substrate or a substrate with a refractive index greater than 1.8.

5. The method of claim 1, wherein the waveguide is included in a lens having a length from 40 mm to 80 mm and a width from 20 mm to 60 mm.

6. The method of claim 1, wherein the screen printing is carried out on a single waveguide, on a plurality of diced waveguides, or on a glass substrate where waveguides are present but not yet diced, using a single screen.

7. The method of claim 1, wherein the deposition of the ink is carried out by an additive process based on silk-screen printing.

8. The method of claim 1, wherein the deposition of the ink is carried out by a subtractive process based on a screen printed protective mask having a negative pattern of the in-coupler grating combined with silk-screen printing.

9. The method of claim 1, further comprising applying a treatment to the ink, wherein the treatment is a thermal treatment or a sintering process or a UV curing; and applying a protective coating on the treated ink.

10. A waveguide with an in-coupler grating having a particle-free optically reflective layer generated by the deposition and sintering of a particle-free ink adhering to the in-coupler grating, wherein the optically reflective layer adhering to the in-coupler grating of the waveguide is obtained with a method for coating an optically reflective layer on a waveguide having an in-coupler grating, the method comprising:
depositing an ink by screen printing on the in-coupler grating of the waveguide.

11. A lens having a length from 40 mm to 80 mm and a width from 20 mm to 60 mm, the lens including a waveguide with an in-coupler grating having a particle-free optically reflective layer generated by the deposition and sintering of a particle-free ink adhering to the in-coupler grating, wherein the optically reflective layer adhering to the in-coupler grating of the waveguide is obtained with a method for coating an optically reflective layer on a waveguide having an in-coupler grating, the method comprising:
depositing an ink by screen printing on the in-coupler grating of the waveguide.

12. A screen printing device comprising:
a loading and unloading system for waveguides;
a handling system configured to handle waveguides loaded by the loading and unloading system;
one or more alignment systems and one or more actuators configured to align and move waveguides handled by the handling system; and
one or more screen printing heads each comprising a screen, one or more squeegees and one or more floodbars configured to apply an ink on waveguides aligned and moved by the one or more alignment systems.

13. The screen printing device of claim 12, wherein the ink comprises a particle-free ink and a silver ink.

14. The screen printing device of claim 12, wherein the waveguides are a plurality of waveguides in a glass wafer, or a plurality of separated and already-cut waveguides arranged in a printing chuck, or a single waveguide.

15. The screen printing device of claim 12, further comprising an air filtering system for cleanrooms of class 1000 or higher.

16. The method of claim 3, wherein the deposition of the ink is carried out by an additive process based on silk-screen printing.

17. The method of claim 3, wherein the deposition of the ink is carried out by a subtractive process based on a screen printed protective mask having a negative pattern of the in-coupler grating combined with silk-screen printing.

18. The method of claim 3, further comprising applying a treatment to the ink, wherein the treatment is a thermal treatment or a sintering process or a UV curing; and applying a protective coating on the treated ink.

19. The screen printing device of claim 13, wherein the waveguides are a plurality of waveguides in a glass wafer, or a plurality of separated and already-cut waveguides arranged in a printing chuck, or a single waveguide.

20. The screen printing device of claim 13, further comprising an air filtering system for cleanrooms of class 1000 or higher.
